(19) United States
(12) Patent Application Publication
(10) Pub. No.: US 2019/0279787 A1
(43) Pub. Date: Sep. 12, 2019

(54) FLAT WIRE, FLAT WIRE MULTILAYER BODY, AND FIXING STRUCTURE FOR FLAT WIRE

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventor: Hiroshi Yamaguchi, Mie (JP)

(21) Appl. No.: 16/335,051

(22) PCT Filed: Sep. 5, 2017
(86) PCT No.: PCT/JP2017/031860

§ 371 Date: Mar. 20, 2019

(30) Foreign Application Priority Data
Sep. 26, 2016 (JP) 2016-186725

(51) Int. Cl. H01B 7/08; H01B 7/02; H01B 17/56; H02G 3/22; H02G 3/30; H01B 3/30; B32B 3/26

(52) U.S. Cl. CPC H01B 7/08; H01B 7/02; H01B 17/56; B32B 3/26; H02G 3/30; H01B 3/30; H02G 3/22

(57) ABSTRACT

An object is to provide a wire to be used as a wiring member that can be easily and securely fixed to another member. A flat wire includes a flat conductor cover portion that covers the flat conductor with a flat shape and has a main surface on at least one side that exhibits self bonding properties. The main surface on at least one side of the cover portion exhibits self clinging properties. A flat wire multilayer body is manufactured by a plurality of flat wires being overlaid in each other in a state in which the main surfaces that exhibit self bonding properties of each of the cover portions are bonded together.

### TECHNICAL FIELD

This invention relates to a flat wire to be used as a wiring member.

### BACKGROUND

Patent Document 1 discloses a twisted pair wire that is made by twisting together two wires that have self fusing properties and each include a thermoplastic insulating cover layer provided around the outer periphery of a linear conductor, and when twisted together, the insulating cover layers of the two wires come into contact and become fixed to each other.

### PRIOR ART DOCUMENT

### Patent Document

Patent Document 1: JP 2015-015221A

### SUMMARY OF THE INVENTION

### Problems to be Solved

However, according to Patent Document 1, the insulating cover layers of the two wires that are in contact with each other become fixed to each other due to the self fusing properties thereof. The contact areas of the two wires is small because the wires have circular cross-sections. For this reason, the fixing strength of the two wires is low.

Here, an object of the present invention is to enable a wire for use as a wire member able to be easily and securely fixed to another member.

### Means to Solve the Problem

In order to solve the problem described above, a flat wire according to a first mode includes a flat conductor and a cover portion that covers the flat conductor with a flat shape and has a main surface on at least one side that exhibits self bonding properties.

A second mode is the flat wire according to the first mode, wherein the main surface on at least one side of the cover portion exhibits self clinging properties.

A third mode has a flat wire multilayer body comprising a plurality of the flat wires according to the first or second mode, wherein the plurality of flat wires are stacked in a state in which the main surfaces that exhibit self bonding properties of each of the cover portions are bonded with each other.

A fixing structure for a flat wire according to a fourth mode includes the flat wire according to the first or second mode and an intervening layer that is provided with an adhesive layer on one main surface side, and is provided with a self bonding layer on an other main surface side, the self bonding layer being formed from the same material as the main surface of the cover portion that exhibits self bonding properties, and the adhesive layer of the intermediate layer being adhered to a fixing target portion, wherein the flat wire is fixed to the fixing target portion when the main surface of the cover portion of the flat wire that exhibits self bonding properties and the self bonding layer are bonded with each other.

### Effect of the Invention

With the first mode, it is possible to fix the main surface of the cover portion surfaces that exhibits self bonding properties to a fixing target portion that is formed from the same material, and fix the flat wire to the fixing target portion with a comparatively large bonding area. For this reason, the flat wire to be used as a wiring member can be easily and securely fixed to another member.

With the second mode, if the main surface of the cover portion that exhibits self clinging properties is pressed against a surface of the fixing target portion formed from the same material, the flat wire that is used as the wiring member can be easily and securely fixed to another member.

With the third mode, a plurality of flat wires can be stacked easily and in a securely fixed state.

With the fourth mode, the flat wire can be easily and securely fixed to the fixing target portion.

### BRIEF DESCRIPTION OF THE DRAWINGS

FIG. 1 is a schematic perspective view showing a flat wire according to an embodiment.

FIG. 2 is a schematic perspective view showing a flat wire multilayer body.

FIG. 3 is a diagram showing an example of a configuration for connecting an other wire 30 to the flat wire.

FIG. 4 is a diagram showing an example of a configuration for connecting the other wire 30 to the flat wire.

FIG. 5 is an illustrative diagram showing an example of a construction for fixing the flat wire to a fixing target portion.

FIG. 6 is an illustrative diagram showing an example of a construction for fixing the flat wire to the fixing target portion.

FIG. 7 is a schematic perspective view showing the flat wire according to a variation.

FIG. 8 is a schematic perspective view showing the flat wire according to another variation.

### DETAILED DESCRIPTION TO EXECUTE THE INVENTION

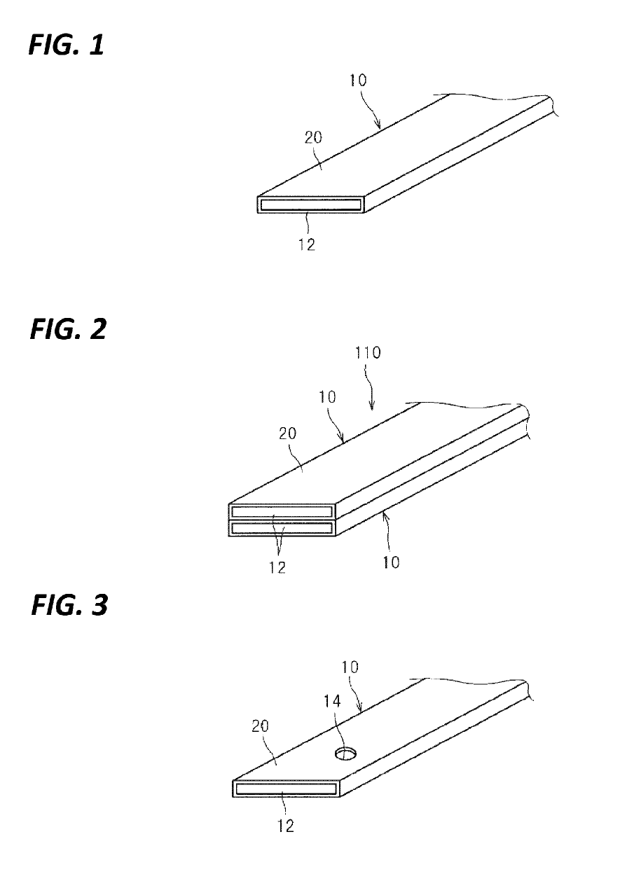

The following describes a flat wire according to an embodiment. FIG. 1 is a schematic perspective view showing a flat wire 10 according to the embodiment.

The flat wire 10 includes a flat conductor 12 and a cover portion 20.

The flat conductor 12 has an elongated shape, and a cross section of the surface thereof that is perpendicular to the length direction thereof is formed with a flat shape (hereinafter “a rectangle extending in one direction”). The flat conductor 12 is formed from a long and narrow belt-shaped metal plate. The flat conductor 12 is formed from a material such as copper, a copper alloy, aluminum, or an aluminum alloy. The flat conductor 12 may also be coated with a metal plating made from tin, nickel, or the like.

The cover portion 20 is an insulating member that covers the flat conductor 12 with a flat shape. The cover portion 20 may be formed by, for example, extrusion coating of the flat conductor 12 with a resin. The cover portion 20 covers the flat conductor 12 with a uniform thickness, and accordingly, the flat wire 10 exhibits a flat shape when observing a cross section of the surface thereof that is perpendicular to the length direction thereof.

A main surface of at least one side of the cover portion 20 exhibits self bonding properties. Here, the cover portion 20 itself is formed from a material that exhibits self bonding properties. Here, self bonding refers to the trait of easily bonding with a member made of the same material. Examples of self bonding properties include, for example, members made of the same material exhibiting the trait of adhering top each other (also referred to as having self clinging properties) by being brought into contact (or preferably pressed together), or the trait of melting into a single body (sometimes referred to as self fusing properties which may be exhibited when heated). As disclosed in JP 2015-15221A, mixtures of synthetic rubber, such as a hydrogenated styrene-butadiene rubber layer or an olefin elastomer layer, or a natural rubber latex, which is used as a base resin, with a terpene resin, a rosin ester type resin, and an oil resin are all known to exhibit self clinging properties at room temperature. Also, butylene rubber is a type of material that exhibits self fusing properties at room temperature, while thermoplastic resins such as EMA (polyethylene methyl acrylate), polyester, and polyamide are types of materials that have self fusing properties when heated.

The cover portion 20 itself is formed from a material that has self bonding properties, and therefore the entire surface of the cover portion 20 exhibits self bonding properties, and, in particular, the two main wide surfaces of the cover portion 20 exhibit self bonding properties.

The flat wire 10 may be preferably used in a vehicle as a wattmeter wiring member that electrically connects a battery to a DC-DC converter, a starter generator, an inverter, or the like.

FIG. 2 is a schematic perspective view showing a flat wire multilayer body 110 that includes a plurality of flat wires 10.

Here, the flat wire multilayer body 110 includes two flat wires 10. The two flat wires 10 are overlaid on each other such that one of the two wide main surfaces of one flat wire 10 is in surface contact with one of the wide main surfaces of the other flat wire 10. Thus, the one main surface and the other main surface of the two flat wires 10 are bonded together to form a single integrated layered body. The flat wire 10 can be produced by overlaying two flat wires 10 on each other and applying force thereto in a direction that unites the two wires.

Here, two flat wires 10 are overlaid on each other, but three or more flat wires 10 may also be overlaid on each other and bonded.

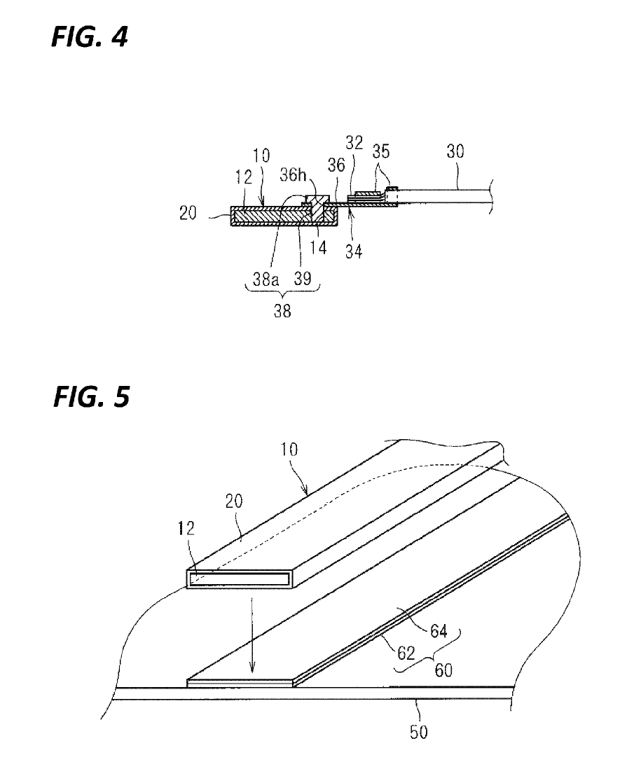

FIGS. 3 and 4 are diagrams showing example configurations for connecting another wire 30 to the flat wire 10. Specifically, FIG. 3 shows a hole 14 formed in the flat wire 10. The hole 14 passes through the flat conductor 12 and a main surface side of the cover portion 20. The hole 14 may or may not also pass through the flat wire 10.

Also, a core portion 32 is exposed from an end portion of the wire 30, and a terminal 34 is crimped. The terminal 34 is formed through pressing a metal plate and includes a crimping portion 35 and a partner connection portion 36. The crimping portion 35 is crimped to the end portion of the wire 30. The mating connection portion 36 has a portion in which a hole 36h is formed. The terminal 34 is a terminal called a round terminal. The terminal and the core of a wire may also be bonded through soldering, ultra sonic joining, and the like.

Thus, when a screw portion 39 of a bolt 38 is passed through the hole 36h of the mating connection portion 36, the bolt portion 38 is screwed and fastened into the hole 14. It is preferable that the leading end portion of the bolt 38 is screwed into the flat conductor only, and does not protrude from the opposite side of the flat wire 10. Of course, a separate nut may also be screwed onto the leading end portion of the bolt 38 if it protrudes from the opposite side of the flat wire 30.

The mating connection portion 36 of the terminal 34 is sandwiched and fixed between a head portion 38a of the bolt 38 and the flat wire 10. Also, as the head portion 38a of the bolt 38 and the periphery thereof come into contact with the mating connection portion 36 of the terminal 34, the screw portion 39 is screwed into the hole 36h and comes into contact with the flat conductor 12. For this reason, the core portion 32 of the wire 30 is electrically connected to the flat wire 10 through the bolt 38, and thus the wire 30 is connected to the flat wire 10.

A rivet or the like may also be used instead of the bolt 38. Also, a configuration is also possible in which the cover portion 20 is removed from the portion that fastens the bolt 38, and the mating connection portion 36 is in direct contact with the flat conductor 12.

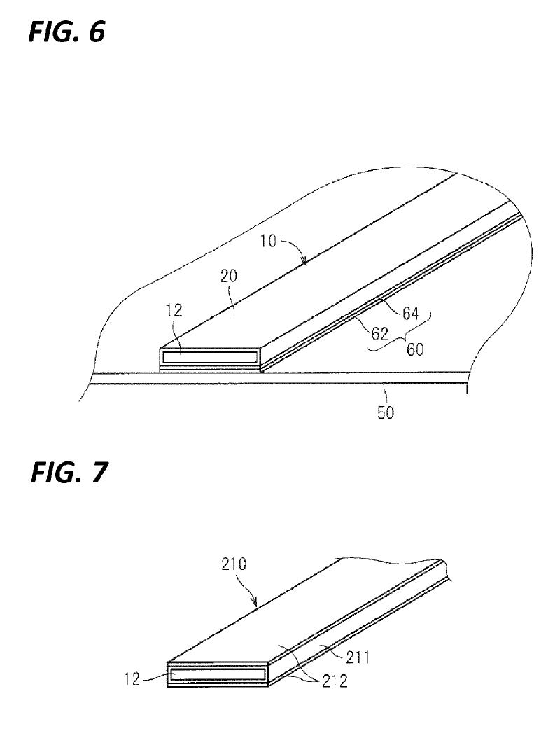

FIGS. 5 and 6 are illustrative diagrams showing example constructions for fixing the flat wire 10 to a fixing target portion 50. It is envisioned that the fixing target portion 50 is a metal panel, a resin panel, or the like of a vehicle.

An adhesive sheet 60 is attached to the fixing target portion 50 as an intervening layer. The adhesive sheet 60 is belt-shaped. The width of the adhesive sheet 60 is preferably the same as the width of the flat wire 10, but this is not essential. The adhesive sheet 60 includes an adhesive layer 62 on one main surface side, as well as another main surface side and a self bonding layer 64. The adhesive layer 62 is a layer that exhibits adhesive properties similarly to that of typical adhesive tape, and is capable of adhering to the fixing target portion 50 that is constituted by a metal, a resin, or the like. The self bonding layer 64 is made from the same material as the main surface of the cover portion 20 that exhibits self bonding properties. Thus, by adhering the adhesive layer 62 to the fixing target portion 50, the adhesive sheet 60 is adhered to the fixing target portion 50.

The flat wire 10 is fixed to the fixing target portion 50 by one main surface of the cover portion 20 of that flat wire being bonded to the self bonding layer 64 of the adhesive sheet 60. Because the cover portion 20 and the self bonding layer 64 are formed from the same material that has self bonding properties, it is possible to bond the flat wire 10 to the self bonding layer 64 of the adhesive layer 62 by bringing the cover portion 20 of the flat wire 10 into contact with the self bonding layer 64 of the adhesive sheet 60 and applying pressure, heat, or the like as necessary (it is preferable to apply heat to the flat wire 10 through electric conduction). This is advantageous because a hole for fixing does not need to be formed in the fixing target portion 50 side.

The adhesive sheet 60 does not exhibit strong adhesive properties or the like to other surrounding members before the self bonding layer 64 of the adhesive sheet 60 is bonded to the flat wire 10, and portions of the flat wire 10 that do not bond with the self bonding layer 64 also do not exhibit strong adhesive properties to other surrounding members. For these reasons, it is unlikely that other members will become unintentionally stuck to the fixing target portion 50 and the flat wire 10.

In all of the examples described above, unlike using double sided tape or the like, tasks such as peeling off sticker release paper and disposing the peeled off sticker release paper are unnecessary, and thus the present invention is convenient in this respect as well.

With the flat wire 10 as configured above, if the main surface of the cover portion 20 that exhibits self bonding properties is brought into contact with a surface of the fixing target portion that is made of the same material as the cover portion, then the flat wire 10 can be fixed to the fixing target portion 50 over a comparatively large bonding surface. For this reason, the flat wire 10 to be used as a wiring member can be easily and securely fixed to another member.

In particular, because the cover portion 20 has self clinging properties, if the cover portion 20 is pressed against a surface of the fixing target portion formed from the same material as the cover portion 20, it is possible to easily and securely fix the flat wire 10 to the fixing target portion 50 with a comparatively large bonding surface.

With the example described above, the flat wire 10 is stacked on another flat wire 10, which is a fixing target portion, and by bonding the main surfaces of the cover portions 20 of these flat wires, a plurality of flat wires 10 can be overlaid on each other easily and in a securely fixed state.

Also, in other examples, the flat wire 10 can be easily and securely fixed to the fixing target portion 50, such as the body of vehicle or the like, via the adhesive sheet 60, which has the adhesive layer 62 and the self bonding layer 64.

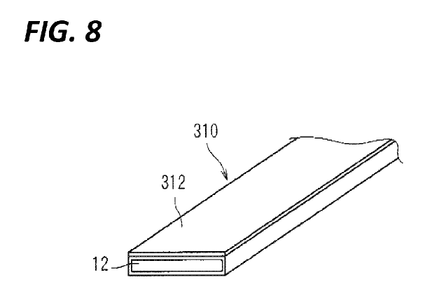

Note that the embodiment above describes an example in which the entirety of the cover portion 20 is formed from a material that has self bonding properties, but, as with a flat wire 210 shown in FIG. 7 and a flat wire 310 shown in FIG. 8, a configuration is also possible in which a self bonding layer 212 or a self bonding layer 312, both of which are formed from a material that has self bonding properties, are formed around the periphery of a cover body portion 211, which is formed from vinyl chloride or the like. The self bonding layer 212 or the self bonding layer 312 may be coated over the cover body portion 211, or may be adhered to the cover body portion 211 with a separate adhesive layer.

The self bonding layer 212 or the self bonding layer 312 are formed on at least one of the two wider main surfaces of the cover body portion 211 among the four surfaces thereof. Here, the self bonding layers 212 are formed on both of the main surfaces of the cover body portion 211 of the flat wire 210. Also, the self bonding layers 212 are formed on both of the main surfaces of the cover body portion 211 of the flat wire 310.

For these reasons, the flat wires 210 and 310 can be fixed together when the comparatively wide main surfaces of the fixing target portions are brought into contact.

Note that the configurations described in the foregoing embodiment and variations can be suitably combined as long as they do not contradict each other. For example, a stack of flat wires 10 may also be fixed to the fixing target portion 50 via the adhesive sheet 60.

Although this invention has been described in detail, the foregoing description is merely an example in every regard, and no aspect of this invention is limited thereto. Any number of embodiments not exemplified can be envisioned as long as they do not deviate from the scope of this invention.

### LIST OF REFERENCE NUMERALS

10, 210, 310 Flat wire

12 Flat conductor

20 Cover portion

50 Fixing target portion

60 Adhesive sheet

62 Adhesive layer

64 Self bonding layer

110 Flat wire multilayer body

211 Cover body portion

212, 312 Self bonding layer

1. A flat wire comprising:
a flat conductor; and
a cover portion that covers the flat conductor with a flat shape and has a main surface on at least one side that exhibits self bonding properties.

2. The flat wire according to claim 1, wherein
the main surface on at least one side of the cover portion exhibits self clinging properties.

3. A flat wire multilayer body comprising a plurality of the flat wires according to claim 1, wherein
the plurality of flat wires are stacked in a state in which the main surfaces that exhibit self bonding properties of each of the cover portions are bonded with each other.

4. A fixing structure for a flat wire, comprising:
the flat wire according to claim 1; and
an intervening layer that is provided with an adhesive layer on one main surface side, and is provided with a self bonding layer on an other main surface side, the self bonding layer being formed from the same material as the main surface of the cover portion that exhibits self bonding properties, and the adhesive layer of the intermediate layer being adhered to a fixing target portion,
wherein the flat wire is fixed to the fixing target portion when the main surface of the cover portion of the flat wire that exhibits self bonding properties and the self bonding layer are bonded with each other.
